(19) United States
(12) Patent Application Publication
(10) Pub. No.: US 2010/0039524 A1
(43) Pub. Date: Feb. 18, 2010

(54) Passing Embedded Data Through A Digital Image Processor

(76) Inventors: Uri Kinrot, Hasharon (IL); Yoav Lavi, Ra'anana (IL); Elchanan Rappaport, Dolev (IL)

Correspondence Address: HICKMAN PALERMO TRUONG & BECKER / TESSERA INC., 2055 GATEWAY PLACE , SUITE 550, SAN JOSE, CA, 95110-1083, US

(21) Appl. No.: 12/504,560

(22) Filed: Jul. 16, 2009

(30) Foreign Application Priority Data
Jan. 10, 2008 (IL) PCT/IL2008/000052

(51) Int. Cl. H04N 5/228

(52) U.S. Cl. 348/222.1; 348/E05.031

(57) ABSTRACT

A method and apparatus for processing an image includes a buffer memory, which is configured to receive and store an input data stream including multiple image lines and one or more embedded data lines, which are interleaved with the image lines and include metadata that are not a part of the image. An image processor receives the input pixel values in succession from the buffer memory and processes the input pixel values so as to generate an output data stream including output pixel values, which are different from the input pixel values. A processing controller detects the one or more embedded data lines and controls the image processor, responsively to detecting the one or more embedded data lines, so that the embedded data lines pass through the image processor without modification of the metadata and are interleaved with the image lines of the output pixel values in the output data stream.

### PRIORITY

This application claims benefit of U.S. Provisional Application 60/880,891 filed Jan. 16, 2007, the entire contents of which are hereby incorporated by reference as if fully set forth herein, under 35 U.S.C. §119(e). This application further claims benefit of International Application PCT/IL2008/000052 filed Jan. 10 2008, entitled “PASSING EMBEDDED DATA THROUGH A DIGITAL IMAGE PROCESSOR,” the entire contents of which are hereby incorporated by reference as if fully set forth herein, under 35 U.S.C. §119(a).

### FIELD OF THE INVENTION

The present invention relates generally to data processing, and specifically to processing of image data that are interleaved with metadata.

### BACKGROUND OF THE INVENTION

The Standard Mobile Imaging Architecture (SMIA) is an open standard developed by Nokia and STMicroelectronics for use by companies making, buying or specifying miniature integrated camera modules for use in mobile applications. Information regarding this standard is available on the Internet at the SMIA-forum Web site. The main object of the standard is to make it possible to connect any SMIA-compliant sensor to any SMIA-compliant host system with matching capabilities and get a working system.

The SMIA 1.0 Part 1: Functional Specification (2004) provides standardized electrical, control and image data interfaces for Bayer sensor modules (i.e., image sensors with RGB mosaic filters). The Bayer sensor module outputs raw data to an image signal processor (ISP) or other processing host. The raw data are output in frames containing multiple lines of pixel values. Each frame begins with one or more embedded data lines, as stated in section 4.7 of the Functional Specification. These embedded data lines contain metadata including the device identifier, frame counter, integration time/gain values, line length, frame length, and frame format description. The frame may also end with one or more additional embedded data lines. The frame format description in the embedded data line at the start of the frame indicates the number of embedded data lines at the start and end of the frame.

### SUMMARY OF THE INVENTION

In some imaging applications, a component in the processing chain may be required to receive and pass through embedded data lines that are interleaved with the lines of image pixel values, while performing image enhancement or other processing functions on the pixel values. It is possible for this purpose to add special buffers and switching logic to accommodate the embedded data lines, and thus bypass the processing functions of the component, but this approach requires that a substantial amount of memory (and hence chip real estate) be added to the component.

Embodiments of the present invention that are described hereinbelow provide a more economical solution, in which the embedded data lines pass through the same buffer memory of an image processing device as is used to hold the image pixel values in preparation for processing. An image processor receives and processes the input pixel values from the buffer memory in order to generate output pixel values (which are different from the input pixel values). A processing controller detects the one or more embedded data lines in the input data stream and controls the image processor so that the embedded data lines pass through the image processor without modification. The embedded data lines are then re-interleaved in the proper location among the image lines of the output pixel values in the output data stream from the image processing device.

There is therefore provided, in accordance with an embodiment of the present invention, a device for processing an image, including: a buffer memory, which is configured to receive and store an input data stream including multiple image lines and one or more embedded data lines, which are interleaved with the image lines, each image line including an input sequence of input pixel values corresponding to a respective row of pixels in an electronic image, and each embedded data line including metadata that are not a part of the image; an image processor, which is coupled to receive the input pixel values in succession from the buffer memory and to process the input pixel values so as to generate an output data stream including output pixel values, which are different from the input pixel values; and a processing controller, which is coupled to detect the one or more embedded data lines and to control the image processor, responsively to detecting the one or more embedded data lines, so that the embedded data lines pass through the image processor without modification of the metadata and are interleaved with the image lines of the output pixel values in the output data stream.

In a disclosed embodiment, the image processor is configured to receive successive matrices of the input pixel values from the buffer memory and to convolve the matrices of the input pixel values with an̂ image enhancement kernel in order to generate the output pixel values.

In some embodiments, the input data stream is generated by a mosaic image sensor, so that the input pixel values are responsive to light of different, respective colors in a predetermined mosaic interleaving, and the image processor is configured to generate the output pixel values in the output data stream with the same interleaving as the input data stream. Typically, the image processor is coupled to convey the output data stream to an image signal processor (ISP), which is configured to read the metadata in the one or more embedded data lines and to combine the output pixel values, responsively to the metadata, in order to generate a color video output image, wherein the input data stream and the output data stream have identical formats.

In some embodiments, the multiple image lines are arranged in one or more image frames, and the one or more embedded data lines occur at a specified location in each of the image frames, and the processing controller is coupled to identify the location in the input data stream and to control the image processor responsively to identifying the location. The one or more embedded data lines may include a first embedded data line and one or more subsequent embedded data lines in each of the image frames, wherein the metadata in the first embedded data line indicate a number and the location of the subsequent embedded data lines, and the processing control may be configured to read and decode the metadata so as to identify the subsequent embedded data lines.

In disclosed embodiments, the device includes framing logic, which is configured to replicate a predetermined number of the data lines at an edge of the image, and to write the replicated data lines to respective locations in the buffer for readout to the image processor, and to write the embedded data lines to a location in the buffer memory so that the embedded data lines will be read out of the buffer prior to processing of the replicated data lines by the image processor. In one embodiment, the buffer memory includes a plurality of buffer lines, which are coupled to respective taps, including at least first and last taps and a center tap, that are coupled to provide the pixel values to the image processor, and the framing logic is configured to write the embedded data lines to a buffer line that is not coupled to the last tap, and the image processor is coupled to receive the embedded data lines from one of the taps other than the center tap.

There is also provided, in accordance with an embodiment of the present invention, a method—for processing an image, including: receiving and storing in a buffer memory an input data stream including multiple image lines and one or more embedded data lines, which are interleaved with the image lines, each image line including an input sequence of input pixel values corresponding to a respective row of pixels in an electronic image, and each embedded data line including metadata that are not a part of the image; conveying the input pixel values in succession from the buffer memory to an image processor, and processing the input pixel values using the image processor so as to generate an output data stream including output pixel values, which are different from the input pixel values; and detecting the one or more embedded data lines and controlling the image processor, responsively to detecting the one or more embedded data lines, so that the embedded data lines pass through the image processor without modification of the metadata and are interleaved with the image lines of the output pixel values in the output data stream.

The present invention will be more fully understood from the following detailed description of the embodiments thereof, taken together with the drawings.

### BRIEF DESCRIPTION OF THE DRAWINGS

FIG. 1 is a block diagram that schematically illustrates an electronic imaging camera, in accordance with an embodiment of the present invention; and

FIG. 2 is a block diagram that schematically shows details of an image enhancement device, in accordance with an embodiment of the present invention.

### DETAILED DESCRIPTION OF EMBODIMENTS

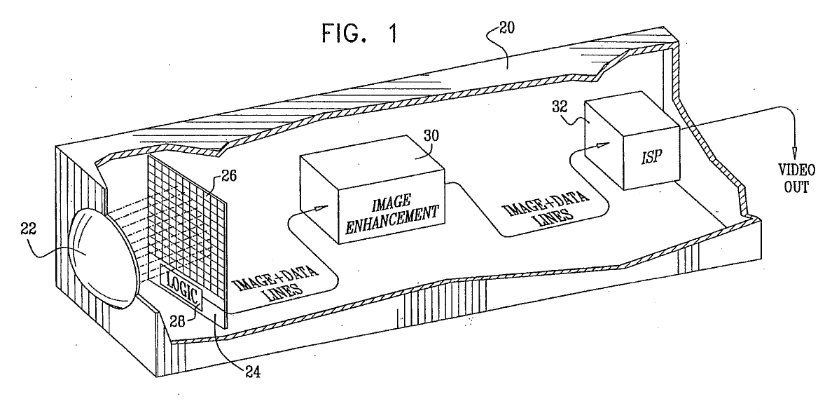

FIG. 1 is a block diagram that schematically illustrates an electronic imaging camera 20, in accordance with an embodiment of the present invention. Objective optics 22 focus light from a scene onto an image sensor module 24. Module 24 comprises an image sensor 26, which is coupled to processing logic 28. Sensor 26 may comprise any suitable type of image sensor known in the art, such as a CCD or CMOS image sensor. Logic 28 converts the analog output of the image sensor to a raw data stream comprising successive lines of digital pixel values, wherein each line contains the values output by a corresponding row of detector elements in sensor 26.

In the present example, as well as in the description that follows, image sensor 26 is assumed to have a Bayer-type mosaic filter, so that each pixel in the image signal output by the sensor is responsive to either red, green or blue light. (The Bayer mosaic is described in U.S. Pat. No. 3,971,065, whose disclosure is incorporated herein by reference.) The pixel values are typically interleaved in the data stream according to the order of the color elements in the mosaic filter, i.e., the sensor outputs one row of RGRGRG . . . (alternating red and green filters), followed by a succeeding row of GBGBGB . . . (alternating green and blue), and so forth in alternating lines. Alternatively, the methods and circuits described hereinbelow may be used, mutatis mutandis, with other types of mosaic sensor patterns, as well as with monochrome image sensors.

In addition to digitizing and outputting the pixel values, logic 28 interleaves lines of embedded data among the lines of pixel values in the data stream. These embedded data typically comprise metadata concerning the image sensor and the image itself, such as the types of metadata that are specified by SMIA, as noted in the Background of the Invention. The term “metadata” should be understood, in the context of the present patent application and in the claims, to include any and all data associated with the image (including, without limitation, the means, conditions, and parameters of image capture) that are not a part of the image itself. SMIA specifies that the embedded data lines be interleaved in specific locations at the beginning and possibly the end of each image frame. Alternatively, the embedded data lines may be incorporated at any location in the data stream that is compatible with subsequent processing components.

The stream of pixel values and embedded data that is output by image sensor module 24 is received as an input data stream for processing by an image enhancement device 30. This device, for example, may perform image restoration functions in the Bayer domain, as described, for example, in PCT international publication WO 2007/054931, whose disclosure is incorporated herein by reference. In this configuration, device 30 treats the red, green and blue pixel values as different, interleaved sub-images, and processes these sub-images in order to reduce the image blur. Device 30 then outputs interleaved red, green and blue enhanced pixel values with reduced blur. Typically, device 30 does not perform any processing on the embedded data, but rather passes these data through without modification so that they can be used by subsequent processing components.

In some embodiments, device 30 outputs the enhanced pixel values in the same order and format in which it received the raw data from image sensor module 24. For example, device 30 may interleave the pixel values in the output sub-images to generate a single output data stream, in which the pixel values are arranged in image frames with the same mosaic interleaving as the input pixel values from sensor module 24. Alternatively, device 30 may be configured to demultiplex and output each sub-image as a separate data block or data stream. Typically, device 30 interleaves the embedded data lines, without modification, among the lines of pixel values in the output data stream. For compatibility with subsequent processing components, particularly when the locations and format of the embedded data lines are dictated by a standard, such as SMIA, it is desirable that device 30 output the embedded data in the same locations and format as in the input stream. As a result, the operation of device 30 can be transparent to the subsequent components, which receive and process the enhanced output frames from device 30 as though they originated directly from a compatible image sensor module.

An image signal processor (ISP) 32 receives the enhanced pixel values and embedded data from device 30 and combines the mosaic sub-images to generate a color video output image (or image sequence) in a standard video format. This output image may be displayed on a video screen (not shown), as well as transmitted over a communication link and/or stored in a memory. The ISP may use the embedded data in setting its own processing parameters. Additionally or alternatively, the ISP may read and store some or all of the embedded data along with the output images.

In embodiments in which device 30 outputs the frames of enhanced pixel values and embedded data in the same format in which it received the input data stream from sensor module 24, ISP 32 may be used interchangeably to process either the output of device 30 or to process the output of sensor module 24 directly. This feature of device 30 is advantageous, inter alia, in that it permits the image enhancement device to be used with an existing sensor module and ISP (including a sensor module and ISP that are compliant with SMIA or another predefined specification) without modification to either the sensor module or the ISP. It also permits the enhancement function of device 30 to be switched on and off simply by activating or deactivating a bypass link (not shown) between the sensor module and the ISP.

Typically, image enhancement device 30 and ISP 32 are embodied in one or more integrated circuit chips, which may comprise either custom or semi-custom components. Although device 30 and ISP 32 are shown as separate functional blocks in FIG. 1, the functions of the image enhancement device and the ISP may be implemented in a single integrated circuit component. Optionally, image sensor module 24 may be combined with device 30 and possibly also ISP 32 on the same semiconductor substrate in a system-on-chip (SoC) or camera-on-chip design. Alternatively, some or all of the functions of device 30 and ISP 32 may be implemented in software on a programmable processor, such as a digital signal processor. This software may be downloaded to the processor in electronic form, or it may alternatively be provided on tangible media, such as optical, magnetic or electronic memory media.

The specific, simplified design of camera 20 in FIG. 1 is shown here by way of example, in order to clarify and concretize the principles of the present invention. These principles, however, are not limited to this design, but may rather be applied in imaging systems of other types in which an image processing component is to process image data while passing through embedded metadata.

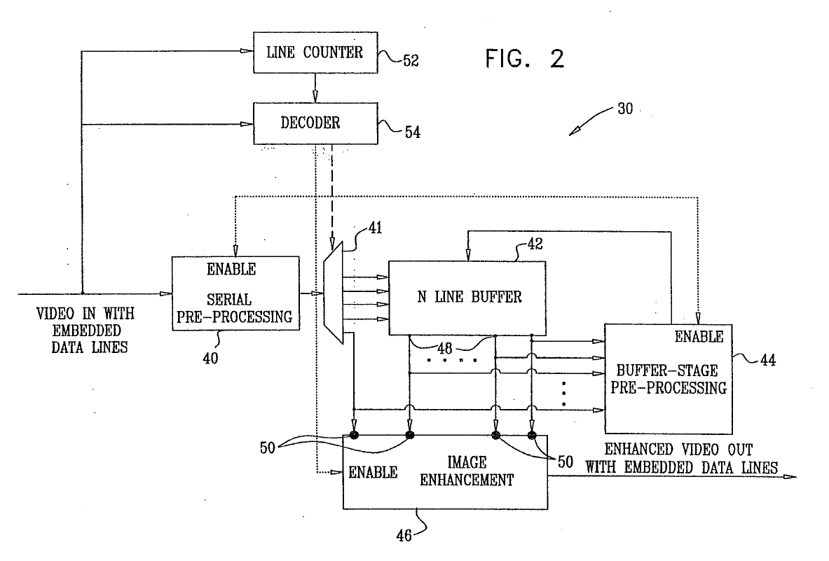

FIG. 2 is a block diagram that schematically shows details of image enhancement device 30, in accordance with an embodiment of the present invention. The stream of input pixel values (referred to in the figure as “video”) from module 24 may initially be processed by a serial preprocessing circuit 40 in device 30. This circuit performs functions, such as gain and green balance adjustment, that operate on individual pixels alone or groups of pixels in the same line. Framing logic 41 writes the pixel values to a buffer memory 42 (referred to hereinafter simply as buffer 42), which holds the pixel values from a certain number {n) of lines of the image and outputs the pixel values as required to an image enhancement circuit 46. Logic 41 performs functions related to framing and proper positioning of embedded data lines in the buffer, as explained hereinbelow.

In typical operation of buffer 42, new pixel values sequentially enter the first line of the buffer, and then shift successively from line to line through the buffer until they reach the end of the last line, where they are discarded. (In the graphical representation of the buffer in FIG. 2, the “lines” are vertical, while “columns” are horizontal, but these geometrical orientations have no functional significance.) Equivalently, the pixel values may be written to static locations in the buffer, such that new values overwrite old values, with moving pointers to indicate the current locations for writing to and reading from the buffer.

The pixel values are typically output from buffer 42 via output taps 48 to input taps 50 of the image enhancement circuit. The buffer may have n output taps, one line apart, which output the pixel values of a column of n pixels. (In practice, the first tap typically provides the latest pixel, at the input to the buffer, as shown in FIG. 2.) The column of the image that is output via taps 48 shifts with each successive input pixel, so that circuit 46 receives a matrix of the pixel values in a window that moves across the image. The matrix may be square (n×n pixels), or it may alternatively have any other suitable shape, depending on the function that is performed by the image enhancement circuit.

Optionally, a buffer-stage preprocessing unit 44 also receives pixel values from output taps 48, processes the values, and then writes the processed values back to buffer 42, typically several pixels at a time. Unit 44 may perform functions such as spike removal, i.e., filtering out image irregularities such as those generated by faulty or dead pixels.

In a typical embodiment, image enhancement circuit 46 convolves the pixel values in a neighborhood of each pixel in the input image with a given image restoration kernel in order to generate an enhanced output pixel value for that pixel. An application of this sort is described, for example, in the above-mentioned WO 2007/054931. The number of lines of data in n-line buffer 42 is typically one less that the number of rows of coefficients in the convolution kernel, as the top line is available to circuit 46 directly. For example, circuit 46 may compute an enhanced output value for each pixel by convolving the input pixel values in an n×n neighborhood centered on the given pixel (assuming n to be odd). Buffering the pixel values for this sort of function will result in a processing delay equal to the time it takes for a given pixel to move through the buffer from the buffer input to the center of the processing neighborhood, i.e., approximately (π−1)/2 times the line clock period of sensor module 24.

When the stream of input data from sensor module 24 includes embedded data lines, the embedded data are also fed by logic 41 to buffer 42 and pass through the buffer to image enhancement circuit 46, which then outputs the embedded data lines in the output stream of enhanced pixel values. For example, assuming sensor module 24 to be SMIA-compliant, each image frame will contain one or more embedded data lines at the start of the frame and may contain one or more additional data lines at the end of the frame. Operation of the components of device 30 is controlled so that the embedded data lines pass through the processing components in the device without modification and are inserted in the proper locations in the output frame.

For this purpose, a line counter 52 counts the lines in each frame and provides the line count to a decoder 54, which serves as the processing controller in device 30. Based on the line count, the decoder determines whether the line currently entering device 30 is a video line containing actual pixel values, or whether it is an embedded data line. In the case of SMIA, for example, the decoder may assume that the first line in each frame is an embedded data line, and may then read and decode the metadata in the first line in order to determine the total number of lines in the frame and the locations of the embedded data lines. Alternatively, the number of embedded data lines can be configured directly by the ISP. Based on this information, when decoder 54 detects the first line of actual pixel values, it asserts an “enable” input to the processing components in device 30, which causes these components to begin performing their normal processing functions.

When the current line contains embedded data, the decoder does not assert the “enable” input. When not enabled, the processing components behave as follows:
1. Serial pre-processing circuit 40 passes through the input data without change. If circuit 40 normally introduces a delay in the pixel values, the same delay is applied to the embedded data.
2. Buffer-stage pre-processing unit 44 refrains from modifying the embedded data.
3. Image enhancement circuit 46 passes the embedded data through to its output without change. Passage of the embedded data through buffer 42 introduces a delay equal to the normal processing delay of circuit 46, so that the proper synchronization is maintained between the embedded data lines and the image lines.

When image enhancement circuit 46 applies neighborhood processing to the pixel values, such as the type of kernel convolution that is described above, it may be necessary to create an artificial “neighborhood” for pixels near the edges of the image frame. This sort of operation is referred to as “framing.” Various framing schemes are known in the art, for example:
a) Some schemes assume that missing pixels beyond the edge of the image should assume the value of the pixel at the edge which is closest to the missing pixel
b) For certain types of input image formats, such as Bayer mosaic inputs, adjacent lines have different color filters, as do adjacent columns, since the filter colors alternate over pairs of lines and pairs of columns. In this case, a variation of scheme (a) may be used, wherein the value of pixels that are located an even number of pixels away from the image edge are assumed to have the value of the edge pixels, while pixels that are located an odd number of pixels away from the edge pixel are assumed to have the value of the last pixel before the edge.
c) In other cases, it is desirable to assume that the spatial spectrum of the image continues beyond the edge. In such cases, the pixels beyond the edge that are required for the image enhancement algorithm are assumed to be a reflection of the pixels just before the edge. For example, if line 0 is the first video line, pixels in line −1 (the first framing line outside the edge) are assumed to have the same values as the corresponding pixels in line 0, pixels in line −2 (the next frame line) are assumed to have the values of the pixels in line 1, etc.
d) A variation of scheme (c) for Bayer-type video formats takes the difference in color filters between adjacent lines and between adjacent columns into consideration. Assuming, again, that the first video line number is 0, the framing pixel values Pi in each line i will be generated as follows:
   P₋₁=P₁; p₋₁=pᵢ for odd i; and p₋ᵢ=Pᵢ₋₂ for even i.

Device 30 may implement the above schemes in a number of different ways. In the embodiment shown in FIG. 2, logic 41 replicates values of pixels in the rows and columns near the edges of each image frame by writing the values to multiple locations in buffer 42, as explained in greater detail hereinbelow. (The numbers of arrows pointing from each block to the next are arbitrarily chosen, solely for the sake of illustration, and do not necessarily reflect the actual numbers of connections.) Decoder 54 controls logic 41 so that this replication is applied only to the pixels near the edges of the image, and not to the embedded data lines. Alternatively, buffer-stage pre-processing unit 44 may serve as the framing logic for performing the pixel replication, by reading and then copy the appropriate values to the desired locations in the buffer. Further alternatively, other framing logic (not shown) may be coupled to taps 48 in order to read out the appropriate framing values to circuit 46.

Table I below illustrates the operation of logic 41 (or equivalently of pre-processing unit 44) in replicating pixel values for purposes of framing, in accordance with an embodiment of the present invention. The table shows the outputs provided by taps 48 from a single column in the buffer, as successive rows enter the buffer from sensor module 24. Here IO through 18 represent the pixel values read out of the first nine rows of the sensor module, while S-2, S-1 and S are three lines of embedded data that precede the lines of pixel values. The taps of the buffer extend over fourteen buffer lines, numbered 0 through 13. (It is assumed in this example that n=15, but the fifteenth line, corresponding to the first tap, is fed to circuit 46 directly from the input to logic 41, as shown in FIG. 2.) All columns in the buffer are treated in the same manner. The time axis is labeled in terms of cycles of the line clock of the sensor module, with the origin at the cycle at which the first line of actual pixel data enters the buffer. As shown in the table, at each cycle in the line clock, the values in each column move up one line.

TABLE I
BUFFER CONTENTS FOR FRAMING

| Buffer | Time | | | | | | | | | | | |
|---|---|---|---|---|---|---|---|---|---|---|---|---|
| Taps | −3 | −2 | −1 | 0 | 1 | 2 | 3 | 4 | 5 | 6 | 7 | 8 |
| 0 | — | — | — | — | — | — | — | S-2 | S-1 | S | I1 | I0 |
| 1 | — | — | — | — | — | | S-2 | S-1 | S | I1 | I0 | I1 |
| 2 | — | — | — | — | — | S-2 | S-1 | S | I1 | I0 | I1 | I0 |
| 3 | — | — | — | — | S-2 | S-1 | S | I1 | I0 | I1 | I0 | I1 |
| 4 | — | — | — | S-2 | S-1 | S | I1 | I0 | I1 | I0 | I1 | I0 |
| 5 | — | — | S-2 | S-1 | S | I1 | I0 | I1 | I0 | I1 | I0 | I1 |
| 6 | — | S-2 | S-1 | S | — | I0 | I1 | I0 | I1 | I0 | I1 | I0 |
| 7 | — | — | — | — | I0 | I1 | I0 | I1 | I0 | I1 | I0 | I1 |
| 8 | — | — | — | — | — | I0 | I1 | I0 | I1 | I0 | I1 | I2 |
| 9 | — | — | — | — | I0 | I1 | I0 | I1 | I0 | I1 | I2 | I3 |
| 10 | — | — | — | — | — | I0 | I1 | I0 | I1 | I2 | I3 | I4 |
| 11 | — | — | — | — | I0 | I1 | I0 | I1 | I2 | I3 | I4 | I5 |
| 12 | — | — | — | — | — | I0 | I1 | I2 | I3 | I4 | I5 | I6 |
| 13 | — | — | — | — | I0 | I1 | I2 | I3 | I4 | I5 | I6 | I7 |
| Input | S-2 | S-1 | S | I0 | I1 | I2 | I3 | I4 | I5 | I6 | I7 | I8 |

In the example shown in Table I, it is assumed that logic 41 implements framing scheme (b), as explained above. For this purpose, logic 41 (or unit 44) replicates the pixel values I0 and I1 to multiple lines of buffer 42, as illustrated in columns 1 and 2 of the table. These replicated values progress upward through the buffer until the pixel value in the first line at the edge of the image, I0, is located at tap #7—the center tap, feeding the center row of image enhancement circuit 46—at time=7. At this point, circuit 46 applies the convolution operation to I0, together with the seven lines of actual pixel values below it and the seven lines of framing values above it, and outputs the enhanced pixel value for this first line. In the next cycle, circuit 46 will generate the enhance pixel value for I1, then I2, and so forth.

To maintain proper timing in the output data stream, logic 41 (or unit 44) writes the embedded data values S-2, S-I and S to buffer 42 so that they will be read out of the buffer in the cycles immediately preceding the readout of 10. Thus, in the example shown in Table I, S-2, S-1 and S are copied in succession to line #6 of the buffer, and progress upward, like the pixel values, until they reach the last tap (tap #0) at time=4, 5 and 6, respectively. As long as the enable input is not asserted by decoder 54, circuit 46 simply reads the data values from tap #0 and passes these values directly to the output, without processing them. Decoder 54 asserts the enable input at time=7, whereupon circuit 46 begins to perform its image enhancement function, as described above.

Thus, buffer 42 is able to receive and handle embedded data lines in exactly the same way as it stores and handles lines of pixel values. No extra memory is required to hold the embedded data, and only minor adaptations are required in device 30 to copy the embedded data values, as well as framing pixel values, to their appropriate locations. Appropriate logic may similarly be adapted to support the other framing schemes mentioned above, as well as to handle embedded data lines occurring at other points in the video stream, such as at the end of an image frame.

Although the embodiment shown in FIG. 2 uses only a single buffer in a particular architecture of device 30, the principles of the present invention may similarly be applied in processing devices using different buffering arrangements, including devices having multiple buffers. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

What is claimed is:

1. A device for processing an image, comprising:
a buffer memory, which is configured to receive and store an input data stream comprising multiple image lines and one or more embedded data lines, which are interleaved with the image lines, each image line comprising an input sequence of input pixel values corresponding to a respective row of pixels in an electronic image, and each embedded data line comprising metadata that are not a part of the image;
an image processor, which is coupled to receive the input pixel values in succession from the buffer memory and to process the input pixel values so as to generate an output data stream comprising output pixel values, which are different from the input pixel values; and
a processing controller, which is coupled to detect the one or more embedded data lines and to control the image processor, responsively to detecting the one or more embedded data lines, so that the embedded data lines pass through the image processor without modification of the metadata and are interleaved with the image lines of the output pixel values in the output data stream.

2. The device according to claim 1, wherein the image processor is configured to receive successive matrices of the input pixel values from the buffer memory and to convolve the matrices of the input pixel values with an image enhancement kernel in order to generate the output pixel values.

3. The device according to claim 1, wherein the input data stream is generated by a mosaic image sensor, so that the input pixel values are responsive to light of different, respective colors in a predetermined mosaic interleaving, and wherein the image processor is configured to generate the output pixel values in the output data stream with the same interleaving as the input data stream.

4. The device according to claim 3, wherein the image processor is coupled to convey the output data stream to an image signal processor (ISP), which is configured to read the metadata in the one or more embedded data lines and to combine the output pixel values, responsively to the metadata, in order to generate a color video output image.

5. The device according to claim 4, wherein the input data stream and the output data stream have identical formats.

6. The device according to claim 1, wherein the multiple image lines are arranged in one or more image frames, and wherein the one or more embedded data lines occur at a specified location in each of the image frames, and wherein the processing controller is coupled to identify the location in the input data stream and to control the image processor responsively to identifying the location.

7. The device according to claim 6, wherein the one or more embedded data lines comprise a first embedded data line and one or more subsequent embedded data lines in each of the image frames, wherein the metadata in the first embedded data line indicate a number and the location of the subsequent embedded data lines, and wherein the processing control is configured to read and decode the metadata so as to identify the subsequent embedded data lines.

8. The device according to claim 1, further comprising framing logic, which is configured
to replicate a predetermined number of the data lines at an edge of the image, and
to write the replicated data lines to respective locations in the buffer for readout to the image processor, and
to write the embedded data lines to a location in the buffer memory so that the embedded data lines will be read out of the buffer prior to processing of the replicated data lines by the image processor.

9. The device according to claim 8, wherein the buffer memory comprises a plurality of buffer lines, which are coupled to respective taps, including at least first and last taps and a center tap, that are coupled to provide the pixel values to the image processor, and wherein the framing logic is configured to write the embedded data lines to a buffer line that is not coupled to the last tap, and wherein the image processor is coupled to receive the embedded data lines from one of the taps other than the center tap.

10. A method for processing an image, comprising:
receiving and storing in a buffer memory an input data stream comprising multiple image lines and one or more embedded data lines, which are interleaved with the image lines, each image line comprising an input sequence of input pixel values corresponding to a respective row of pixels in an electronic image, and each embedded data line comprising metadata that are not a part of the image;
conveying the input pixel values in succession from the buffer memory to an image processor, and processing the input pixel values using the image processor so as to generate an output data stream comprising output pixel values, which are different from the input pixel values; and
detecting the one or more embedded data lines and controlling the image processor, responsively to detecting the one or more embedded data lines, so that the embedded data lines pass through the image processor without modification of the metadata and are interleaved with the image lines of the output pixel values in the output data stream.

11. The method according to claim 10, wherein processing the input pixel values comprises receiving successive matrices of the input pixel values from the buffer memory, and convolving the matrices of the input pixel values with an image enhancement kernel in order to generate the output pixel values.

12. The method according to claim 10, wherein the input data stream is generated by a mosaic image sensor, so that the input pixel values are responsive to light of different, respective colors in a predetermined mosaic interleaving, and wherein processing the input pixel values comprises generating the output pixel values in the output data stream with the same interleaving as the input data stream.

13. The method according to claim 12, and comprising conveying the output data stream to an image signal processor (ISP), which is configured to read the metadata in the one or more embedded data lines and to combine the output pixel values, responsively to the metadata, in order to generate a color video output image.

14. The method according to claim 13, wherein the input data stream and the output data stream have identical formats.

15. The method according to claim 10, wherein the multiple image lines are arranged in one or more image frames, and wherein the one or more embedded data lines occur at a specified location in each of the image frames, and wherein controlling the image processor comprises identifying the location in the input data stream and controlling the image processor responsively to identifying the location.

16. The method according to claim 15, wherein the one or more embedded data lines comprise a first embedded data line and one or more subsequent embedded data lines in each of the image frames, wherein the metadata in the first embedded data line indicate a number and the location of the subsequent embedded data lines, and wherein identifying the location comprises reading and decoding the metadata so as to identify the subsequent embedded data lines.

17. The method according to claim 10, wherein receiving and storing the input data stream comprises
replicating a predetermined number of the data lines at an edge of the image, and
writing the replicated data lines to respective locations in the buffer so as to frame the image for readout to the image processor, and
writing the embedded data lines to a location in the buffer memory so that the embedded data lines will be read out of the buffer prior to processing of the replicated data lines by the image processor.

18. The method according to claim 17, wherein the buffer memory comprises a plurality of buffer lines, which are coupled to respective taps, including at least first and last taps and a center tap, that are coupled to provide the pixel values to the image processor, and wherein writing the embedded data lines comprises writing the embedded data lines to a buffer line that is not coupled to the last tap, and wherein the image processor is coupled to receive the embedded data lines from one of the taps other than the center tap.
